(19) United States
(12) Patent Application Publication
(10) Pub. No.: US 2024/0413485 A1
(43) Pub. Date: Dec. 12, 2024

(54) SEPARATOR SUITABLE FOR USE IN LITHIUM ION BATTERIES

(71) Applicant: TEIJIN ARAMID B.V., Arnhem (NL)

(72) Inventors: Johan BOS, Apeldoorn (NL); Richard VISSER, Arnhem (NL); Yen VU, Westervoort (NL); Jan Cees TIECKEN, Didam (NL); Edo MUGGE, Wijchen (NL)

(73) Assignee: TEIJIN ARAMID B.V., Arnhem (NL)

(21) Appl. No.: 18/697,574

(22) PCT Filed: Oct. 26, 2022
(86) PCT No.: PCT/EP2022/079915

§ 371 Date: Apr. 1, 2024

(30) Foreign Application Priority Data
Oct. 29, 2021 (EP) 21205546.1

(51) Int. Cl. H01M 50/454; D21H 19/72; H01M 10/0525; H01M 50/403; H01M 50/423; H01M 50/44; H01M 50/446; H01M 50/491

(52) U.S. Cl. CPC H01M 50/454; D21H 19/72; H01M 10/0525; H01M 50/403; H01M 50/423; H01M 50/44; H01M 50/446; H01M 50/491

(57) ABSTRACT

The invention pertains to a separator suitable for use in lithium ion batteries which comprises a core paper comprising 30-70 wt. % aramid shortcut fiber, 10-45 wt. % PET, and 5-40 wt. % of a binder, the core paper having a grammage of 5-30 g/m2 and a thickness of 5-30 micron, wherein at least one side of the core paper is provided with a coating layer, said coating layer comprising refractory particles and a coating binder, wherein the separator has a surface pore size on the side of the paper provided with the coating layer which is such that at least 90 number % of the surface pores has a pore size of at most 0.5 micron.

The present invention pertains to a separator paper suitable for use in lithium ion batteries.

Lithium ion batteries, also indicated as Li-ion batteries find use in many applications where high energy density, high voltage, and rechargeability are desired. They can in particular be found in many mobile devices.

The main elements of a Li-ion battery are positive electrode, a negative electrode, a separator and an electrolyte. The separator is provided between the positive electrode and the negative electrode. Its main function is to physically isolate the positive electrode from the negative electrode, so as to prevent short-circuiting within the battery while allowing lithium ions to pass through the electrolyte-containing separator.

Commercially available Li-ion cells use polyolefin, e.g., polyethylene or polypropylene as a separator.

U.S. Pat. No. 9,431,643 describes a separator of a lithium-ion battery, comprising a substrate membrane; and a coating provided on a surface of the substrate membrane. The substrate membrane is preferably selected from at least one of polyethylene membrane, polypropylene membrane, polypropylene/polyethylene/polypropylene composite membrane, aramid membrane and polyimide membrane.

EP2955773 describes a non-woven fabric base for a lithium ion secondary battery separator composed mainly (i.e. at least 70 wt. %) of PET, namely a crystallised PET fiber and a PET binder.

US2012251890 describes a membrane comprising a flat, flexible substrate having a plurality of openings and having a porous inorganic coating situated on and in the substrate. The substrate comprises aramid fibers and fibers with a melting point that is lower than the decomposition point of the polyaramide fibers.

While polyolefin-based separators show adequate properties, it has been found that there is room for improvement. In particular, there is need in the art for a separator which combines low thickness, good dimensional stability, and good thermal stability and thermal conductivity with good barrier properties.

The present invention provides a separator which meets these requirements.

The invention pertains to a separator suitable for use in lithium ion batteries which comprises a core paper comprising 30-70 wt. % aramid shortcut fiber, 10-45 wt. % PET, and 5-40 wt. % of a binder, the core paper having a grammage of 5-30 g/m2 and a thickness of 5-30 micron, wherein at least one side of the core paper is provided with a coating layer, said coating layer comprising refractory particles and a coating binder, wherein the separator has a surface pore size on the side of the paper provided with the coating layer which is such that at least 90 number % of the surface pores has a pore size of at most 0.5 micron.

It has been found that the combination of the different elements of the claims ensures that a separator, sometimes also indicated as separator paper, with good properties is obtained. This will be discussed in more detail below.

The invention is illustrated by the following FIGURES, without being limited thereto or thereby.

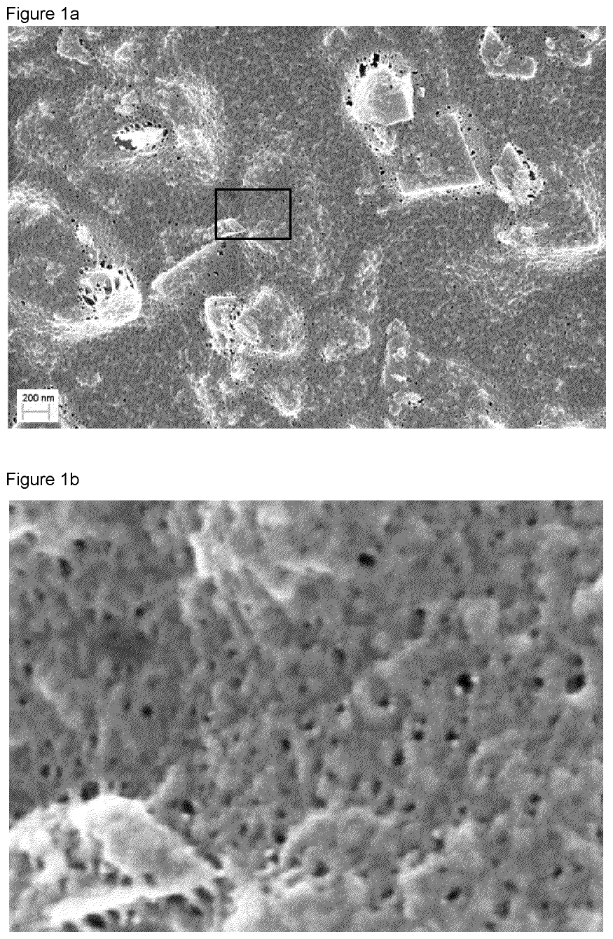

FIG. 1a is a SEM picture of the surface of a separator of the invention. FIG. 1b is an enlargement of the box in FIG. 1a and shows the surface pores as black “holes”.

It is an important feature of the separator paper of the present invention that it has a surface pore size on the side of the paper provided with the coating layer which is such that at least 90 number % of the surface pores has a pore size of at most 0.5 micron. If this requirement is not met, the barrier properties of the separator will be insufficient. As is the intention to limit the number of pores with a pore size above 0.5 micron, it will be clear that the pore size is the maximum diameter of the pore at issue.

As will be clear to the skilled person, the surface pore size can be determined by microscopic inspection of the surface, e.g., using scanning electron microscopy (SEM) with appropriate image analysis software. It is well within the scope of the skilled person to select contrast and magnification which will allow measurement of the pore size, with the help of standard software. One possibility would be to manually draw lines over the longest axis of a pore, and have the software determine the lengths of the lines applied. Depending on the apparatus used, more sophisticated approaches may also be possible.

It is preferred for the surface pore size of the separator on the side provided with the coating layer to be such that at least 95 number % of the surface pores has a pore size of at most 0.5 micron. It is preferred for the surface pore size of the separator on the side provided with the coating layer to be such that at least 80 number % of the surface pores has a pore size of at most 0.4 micron, more preferably at most 0.3 micron.

In one embodiment the number average pore size of the surface pores of the separator on the side provided with the coating layer is at most 0.3 micron, in particular at most 0.2 micron, more in particular at most 0.10 micron.

It has been found that the specific combination of core paper and coating layer makes it possible to obtain a separator paper which has the required surface pore size in combination with the desired further properties described herein.

The core paper has a grammage of 5-30 g/m2 and a thickness of 5-30 micron. If the core paper has a grammage of less than 5 g/m2 or a thickness of less than 5 micron, the separator paper will be difficult to process in a roll-to-roll manufacturing process. Additionally, its barrier properties to prevent short-circuiting may be insufficient. On the other hand, if the grammage of the core paper is above 30 g/m2 or the thickness is above 30 microns, the paper will be too thick and too heavy to be commercially attractive. To balance these properties it may be preferred for the core paper to have a grammage of at least 7 g/m2. It may also be preferred for the core paper to have a grammage of at most 25 g/m2, in particular at most 20 g/m2, more in particular at most 15 g/m2, in some embodiments at most 10 g/m2.

As regards the thickness, for the reasons given above for the grammage it may be preferred for the core paper to have a thickness of at least 10 micron, It may also be preferred for the core paper to have a thickness of at most 25 micron, in particular at most 20 micron, in some embodiments at most 15 micron.

The core paper comprises 30-70 wt. % aramid shortcut fiber, 10-45 wt. % PET, and 5-40 wt. % binder.

In the context of the present specification aramid refers to an aromatic polyamide which is a condensation polymer of aromatic diamine and aromatic dicarboxylic acid halide. Aramids may exist in the meta- and para-form, both of which may be used in the present invention. The use of aramid wherein at least 85% of the bonds between the aromatic moieties are para-aramid bonds is considered preferred. As typical members of this group are mentioned poly(paraphenylene terephthalamide), poly(4,4′-benzanilide terephthalamide), poly(paraphenylene-4,4′-biphenylenedicarboxylic acid amide) and poly(paraphenylene-2,6-naphthalenedicarboxylic acid amide, copoly(para-phenylene/4,4′-dioxydiphenylene terephthalamide), or copoly(para-phenylene/3,4′-dioxydiphenylene terephthalamide). The use of aramid wherein at least 90%, more in particular at least 95%, of the bonds between the aromatic moieties are para-aramid bonds is considered preferred. The use of poly(paraphenylene terephthalamide), also indicated as PPTA is particularly preferred. This applies to all aramid components present in the paper according to the invention, unless specified otherwise. More in particular, it may be preferred for the aramid in the core paper to consist for at least 10 wt. % of para-aramid, to ensure adequate dimensional stability. This can be effected, e.g., by using meta-aramid shortcut in combination with para-aramid fibrid, para-aramid shortcut in combination with meta-aramid fibrid, a mixture of meta- and para-aramid shortcut in combination with meta-aramid fibrid, para-aramid fibrid, or a combination thereof, or in any other combination. In one embodiment, the aramid in the core paper consists for at least 20 wt. % of para-aramid, in some embodiments at least 40 wt. %, in some embodiments at least 60 wt. %, or at least 80 wt. %, or at least 90 wt. %. In one embodiment, all aramid components in the core paper are para-aramid components.

Aramid shortcut fiber, also known as aramid floc, is known in the art. It is generally obtained by cutting aramid fibers to the desired length, in general a length in the range of 0.5-25 mm. In a preferred embodiment the average length is at least 2 mm, in particular at least 3 mm. In some embodiments it may be at least 4 mm. The average length of the shortcut preferably is at most 15 mm, in one embodiment at most 10 mm.

The shortcut generally has a linear density in the range of 0.05-5 dtex. Shortcut with linear densities below 0.05 dtex and long length have been found difficult to process. Shortcut with a linear density above 5 dtex may result in paper with less attractive properties. For processing reasons it may be preferred for the shortcut to have a linear density of at least 0.3 dtex. On the other hand, it has been found that the use of shortcut with a lower linear density results in a separator with improved properties. Accordingly, it may be preferred for the aramid shortcut fiber to have a linear density of at most 1.1 dtex, in particular at most 0.9 dtex, more in particular at most 0.7 dtex, in some embodiments most 0.55 dtex.

The shortcut preferably has a diameter of at most 10 micron, in particular at most 8 micron.

The shortcut may be para-aramid shortcut, meta-aramid shortcut, or a mixture of meta and para-aramid shortcut. The use of para-aramid shortcut is considered preferred.

The core paper contains 30-70 wt. % aramid shortcut fiber. If the amount of shortcut is below 30 wt. %, the strength and dimensional stability of the paper will be insufficient. If the amount of shortcut is above 70 wt. %, there is insufficient room for the other components of the paper, which are required to obtain the desired properties. It may be preferred for the core paper to contain more than 30 wt. % shortcut, in particular at least 32 wt. % shortcut, more in particular at least 35 wt. % of shortcut, or at least 40 wt. % shortcut, or at least 45 wt. % shortcut, and/or at most 60 wt. % shortcut, in particular at most 55 wt. % shortcut.

The core paper of the separator of the present invention contains 5-40 wt. % of a binder, preferably 10-35 wt. %.

The binder is intended to help keep the paper together. In general, the binder is a polymer. It may be fibrous in nature, but non-fibrous binders, also indicated as resinous binders or polymer binders may also be used. As separators may reach high temperatures, temperature stability is an important feature. Therefore, the use of heat-resistant polymers, such as polymers that do not degrade under the conditions prevailing during use of the battery, is considered preferred. Degradation includes chemical degradation but also physical degradation. Examples of suitable heat resistant polymers are polyaramids, polyarylates, polyimides, polybenzoxazoles, polyethersulfones, polyurethanes, polyacrylics, aromatic polyethers, and heat-resistant crosslinked polyesters. Thermoset systems based on e.g. phenolic resins, melamines and epoxys may also be used.

In one embodiment, the binder is selected from one or more of aramid fibrid, aramid pulp, jetspun aramid fibrid, jetspun aramid pulp, and combinations thereof. Within this group the use of aramid fibrid, in particular para-aramid fibrid may be preferred.

In another embodiment the binder is a heat-resistant polymer, in particular a heat-resistant polymer selected from the group of polyimides, polybenzoxazoles, polyethersulfones, polyurethanes, polyacrylics, aromatic polyethers, heat-resistant crosslinked polyesters, phenolic resins, melamines and epoxys. It may be preferred for the binder to be a heat-resistant crosslinked polyester, e.g., a heat-resistant crosslinked polyester with hexamethoxymethylmelamine as crosslinker.

Within the context of the present specification the term aramid fibrid refers to small, non-granular, non-fibrous, non-rigid film-like particles. The film-like fibrid particles have two of their three dimensions in the order of microns, and have one dimension less than 1 micron. In one embodiment, the fibrid used in the present invention has an average length in the range of 0.2-2 mm, and average width in the range of 10-500 microns, and an average thickness in the range of 0.001-1 microns. In one embodiment, the aramid fibrid comprises less than 40%, preferably less than 30%, of fines, wherein fines are defined as particles having a length weighted length (LL) of less than 250 micron.

Meta-aramid fibrid may, e.g., be obtained by shear precipitation of polymer solutions into coagulating liquids as is well known from U.S. Pat. No. 2,999,788. Fibrid of wholly aromatic polyamides (aramids) are also known from U.S. Pat. No. 3,756,908, which discloses a process for preparing poly(meta-phenylene isophthalamide) (MPIA) fibrids. Para-aramid fibrid can, e.g., be obtained by high shear processes such as for example described in WO2005/059247, which fibrid is are also called jet-spun fibrid.

Para-aramid fibrid, meta-aramid fibrid, or a combination thereof may be used. It is preferred for the aramid fibrid to be para-aramid fibrid, in particular para-aramid fibrid with a Schopper-Riegler (SR) value between 50 and 90, preferably between 70 and 85. This fibrid preferably has a specific surface area (SSA) of less than 10 m2/g, more preferably between 0.5 and 10 m2/g, most preferably between 1 and 4 m2/g.

In one embodiment, fibrid is used with a LL0.25 of at least 0.3 mm, in particular of at least 0.5 mm, more in particular at least 0.7 mm. In one embodiment the LL0.25 is at most 2 mm, more in particular at most 1.5 mm, still more in particular at most 1.2 mm. LL0.25 stands for the length weighted length of the fibrid particles wherein particles with a length below 0.25 mm are not taken into account.

The binder may also comprise aramid pulp or aramid jet-spun pulp.

Aramid pulp is well known in the art. Aramid pulp may be derived from aramid fibres which are cut to a length of, e.g., 0.5-6 mm, and then subjected to a fibrillation step, wherein the fibers are pulled apart to form the fibrils, whether or not attached to a thicker stem. Pulp of this type may be characterized by a length of, e.g., 0.5-6 mm, and a Schopper-Riegler of 15-85. In some embodiments, the pulp may have a surface area of 4-20 m2/g.

Within the context of the present specification, the term pulp also encompasses fibrils, i.e., “pulp” which predominantly contains the fibrillated part and little or no fiber stems. This pulp, which is sometimes also indicated as aramid fibril, can, e.g., be obtained by direct spinning from solution, e.g. as described in WO2004/099476. In one embodiment the pulp has a structural irregularity expressed as the difference in CSF (Canadian Standard Freeness) of never dried pulp and dried pulp of at least 100, preferably of at least 150. In one embodiment fibrils are used having in the wet phase a Canadian Standard Freeness (CSF) value less than 300 ml and after drying a specific surface area (SSA) less than 7 m2/g, and preferably a weight weighted length for particles having a length >250 micron (WL 0. 25) of less than 1.2 mm, more preferably less than 1.0 mm. Suitable fibrils and their preparation method are described, e.g., in WO2005/059211.

The core paper contains 5-40 wt. % of a binder. If the amount of binder is too low, the strength of the core paper will be insufficient. It is therefore preferred for the amount of binder to be at least 10 wt. %, in particular at least 15 wt. %. On the other hand, if the amount of binder is too high, the permeability for lithium ions may be insufficient. It may be preferred for the amount of binder to be at most 35 wt. %, in particular at most 30 wt. %, in some embodiments at most 25 wt. %.

The core paper contains 10-45 wt. % PET.

PET is knows in various forms like particulates, flakes, fibrids and fibers. Surprisingly, if the PET is incorporated in the core paper in the paper manufacturing process in the form of fibers, the paper formation expressed in terms of pinhole reduction is improved. This is therefore a preferred embodiment of the present invention. It is thus preferred for the core paper to be manufactured using 10-45 wt. % of PET fiber. It is also preferred for all PET in the core paper to be provided in the form of fibers.

PET(polyethyleneterephthalate) fibers are known in the art, e.g., from U.S. Pat. No. 6,411,497. In one embodiment the PET fibers used in the core paper in accordance with the present invention generally have a length in the range of 0.5-25 mm. As too long fibers may not give good paper properties, it is considered preferred for the fibers to have a length of at most 15 mm, in particular at most 10 mm, more in particular at most 6 mm. As too short fibers may not provide sufficient performance, it may be preferred for the fibers to have a length of at least 2 mm, in particular at least 3 mm. The PET fibers generally have a linear density in the range of 0.01-0.20 dtex. Fibers with a linear density below 0.01 dtex are not attractive from an economic point of view, as they are difficult to obtain. If the linear density is too high, the advantages associated with the presence of the fiber will not be obtained, and the pore size of the paper will be too large. It may be preferred for the PET fiber to have a linear density of at most 0.15 dtex, in particular at most 0.1 dtex. It may also be preferred for the PET fiber to have a linear density of at least 0.01 dtex, in particular at least 0.03 dtex.

The PET is present in the core paper in an amount of 10-45 wt. %. If the amount of PET is too low, the advantages associated with its presence will not be obtained.

On the other hand, if the amount of PET is too high, the dimensional stability of the separator at higher temperatures may be affected, i.e., the risk of shrinkage at higher temperatures will increase. It may be preferred for the amount of PET to be at least 15 wt. %, in particular at least 20 wt. %, more in particular at least 30 wt. %. On the other hand, it may be preferred for the amount of PET in the core paper to be at most 40 wt. %, in particular at most 35 wt. %.

If so desired, the core paper may contain 0.1-10 wt. % of polyamido-amine epichlorohydrin (PAE), which has been found to increase the strength of the paper. Polyamido-amine epichlorohydrin (PAE) polymers are known in the art and require no further elucidation. PAE resins are commercially available from, int. al., Solenis under the trade name Kymene. The PAE resin generally has an average molecular weight of at least 10.000 g/mole, e.g., in the range of 50.000 to 2.000.000 g/mole. It may be preferred for the amount of PAE resin present in the paper to be at most 8 wt. %, in particular at most 5 wt. %, in some embodiments at most 4.5 wt. %, at most 4.0 wt. %, or at most 3 wt. %. An amount of at most 2 wt. % may also be preferred. On the other hand, it may be preferred for the amount of PAE to be at least 0.3 wt. %, in particular at least 0.5 wt. %. The PAE, if used, can be added to the paper at any stage in the paper manufacturing process, e.g., to a suspension of one or more starting materials or a mixture thereof, or to the final paper. It is also possible to contact the final paper with a PAE solution.

The core paper used in the present invention can be manufactured by methods known in the art. In one embodiment, a suspension, generally an aqueous suspension, is prepared comprising at least some of the components, in particular solid fibrous components, the suspension is applied onto a porous screen, so as to lay down a web of randomly interwoven material onto the screen. Liquid medium is removed from the web, e.g., by pressing and/or applying vacuum, followed by drying to make paper. In one embodiment, all components of the paper are provided in the suspension. In another embodiment, some components are provided to the suspension and further components are applied on the paper. For example, a polymer binder may be applied by spraying or coating to a web of randomly interwoven material prepared from the fibrous components, e.g., analogous to the process described in U.S. Pat. No. 5,389,716 or U.S. Pat. No. 6,838,401.

If so desired, the dried paper is subjected to a calendering step. Calendering steps are known in the art. They generally involve passing the paper through a set of rolls, optionally at elevated temperatures.

In one embodiment the manufacture of the paper encompasses a heat treatment, in which the paper is subjected to a temperature of at least 175° C., in particular at least 200° C., more in particular at least 240° C., still more in particular at least 260° C. It has been found that such heat treatment leads to improved paper properties, in particular one or more of increased breaking force (BF), increased breaking tenacity (BT) and increased elongation at break (EaB). Although not wishing to be bound by theory, it is suspected that as the effect is more pronounced for papers containing PET the effect may be related to a softening or melting of the PET. As a maximum temperature a value of at most 400° C. may be mentioned. Above this temperature degradation of the polymer may occur. In general, a temperature of at most 350° C., in particular at most 320° C., more in particular at most 300° C. will suffice. The heat treatment does not need to take long. In general, a heat treatment of at most 2 hours will suffice. Depending on the equipment used a time in the range 1 second to 1 hour, in particular 1-second to 30 minutes, more in particular 1 second to 10 minutes, even more in particular 1 second to 5 minutes, or even 1 second to 30 seconds may be mentioned provided that the paper reaches the appropriate temperature.

The heat treatment can be carried out in batch or continuous, using various methods, e.g., in an oven, using a hot-plate or a heated roll, through IR radiation, or using hot air. Combinations of methods may also be applied.

Where a polymer binder is used, in particular a crosslinkable or curable polymer binder, it is possible to effect a partial curing step just after paper manufacture with complete curing taking place in the heat treatment step/calendering step, e.g., analogous to what is described in U.S. Pat. No. 6,838,401.

In the separator according to the invention, the core paper is provided with a coating layer on at least one of its surfaces. The coating layer comprises refractory particles and a coating binder. After application on the paper, the refractory particles together with the coating binder become part of the paper structure, with the particles with the coating binder being embedded in the paper structure partially or in their entirety. This can be seen when a cross section of the paper is viewed through a microscope.

The coating layer comprises a coating binder and refractory particles. The refractory particles show thermal conductivity, but are electrically insulating. The coating layer is intended to reduce the surface pore size of the separator. Additionally, the presence of the thermally conductive particles ensures good dissipation of heat over the separator, resulting in a reduced heating rate and risk of overheating within a short period of time. Their presence may also contribute to improved stability of the Li-ion battery, because they may scavenge HF formed in the battery during use.

The coating layer is applied on at least one surface of the core paper. It is preferred for both sides of the core paper to be provided with the coating layer.

The refractory particles are inert under the conditions prevailing in the battery. They are generally selected from inorganic oxide particles, inorganic nitride particles, and inorganic carbide particles. Suitable inorganic oxide materials include aluminum oxide (e.g., gamma-alumina), aluminum oxyhydroxide (e.g., boehmite), zirconia, silica, titania, magnesia. Boron nitride may be mentioned as a suitable inorganic nitride. Silicon carbide may be mentioned as a suitable inorganic carbide. Alumina is considered preferred as it has appropriate thermoconductive properties while at the same time being economically attractive. Combinations of various types of particles may also be used.

The refractory particles generally have an average particle diameter (in the context of the present application the d50) in the range of 100-1000 nm, preferably between 200 and 600 nm. If the particles are too large the desired surface pore size will not be obtained. If the particles are too small, they may interfere with other properties of the separator.

The coating layer can be applied to the paper as a composition comprising a mixture of a coating binder, refractory particles, generally one or more solvents, and optionally one or more additives.

The coating binder is intended to keep the particles together and bind them to the core paper. Coating binders are polymeric in nature, and suitable binders include, for example, polyvinylidene fluoride (PVDF); polyurethane, polyethylene oxide (PEO), polypropylene oxide (PPO); polyacrylonitrile (PAN), polyacrylamide, polymethylacrylate, polymethylmethacrylate, polyvinylacetate, polyvinylpyrrolidone, polytetraethylene glycol diacrylate, cellulose nano- or micro fibers, copoly(para-phenylene/4,4′-dioxydiphenylene terephthalamide), copoly(para-phenylene/3,4′-dioxydiphenylene terephthalamide), metaphenylene isophthalamide (MPIA available under the trade name Teijin Conex), copolymers of the foregoing, and combinations thereof.

The separator generally comprises 0.5 to 20 wt. % of binder derived from the coating, in particular 1 to 10 wt. %, more in particular 2.5 to 8 wt. %.

From a chemical point of view the paper binder and the coating binder may be the same or different.

The coating binder is dissolved or dispersed in the solvent. The nature of the solvent depends on the nature of the polymeric binder, to allow suitable solution or dispersion. Water or organic solvents may be used. Depending on the nature and properties of the solvent, it can be removed from the system by evaporation (water, volatile solvents such as ethanol) or through other means, e.g., by adding a non-solvent to coagulate the polymer, and removing the solvent by washing. Solvent removal may be accelerated by the application of heat and/or a reduced pressure.

Examples of suitable organic solvents include alcohols, e.g., ethanol, propanol, isopropyl alcohol, ketones, e.g., acetone, methyl-ethyl ketone, acetates and the like. Further suitable solvents include polar, aprotic solvents such as DMAc, DMSO, DMF, and NMP. NMP may be considered preferred.

The coating may be applied using methods known in the art, e.g., using a roller, a doctor blade, a slot-die, or through any other suitable method.

In another embodiment the coating layer may be provided by spatial atomic layer deposition of the oxide particles, followed by application of a coating binder, generally using a solvent.

The separator of the present invention comprises a core paper at least one side of which is provided with a coating layer. As indicated above, after application of the coating layer, the refractory particles become part of the paper structure, with the particles being embedded in the paper structure partially or in their entirety. This can be seen when a cross section of the paper is viewed through a microscope. The separator generally contains 10-60 wt. % of refractory particles, in particular 20-55 wt. %, more in particular 35-50 wt. %.

The separator according to the invention will be discussed further below.

For the % of surface pores, reference is made to what is stated above.

The separator of the present invention generally has a grammage of 5-35 g/m2. If the separator has a grammage of less than 5 g/m2, its barrier properties to prevent short-circuiting may be insufficient. On the other hand, if the grammage of the separator is above 35 g/m2, the separator will be too thick and too heavy to be commercially attractive. To balance these properties it may be preferred for the separator to have a grammage of at least 6 g/m2. It may also be preferred for the separator to have a grammage of at most 25 g/m2, in particular at most 20 g/m2, more in particular at most 15 g/m2, in some embodiments at most 10 g/m2.

The separator of the present invention generally has a thickness of 5-35 micron. If the separator is too thin, its barrier properties may be insufficient. On the other hand, if the separator is too thick it will not be attractive for commercial operation. It may be preferred for the separator to have a thickness of at least 7 micron. It may also be preferred for the separator to have a thickness of at most 25 micron, in particular at most 20 micron, in some embodiments at most 15 micron. In one embodiment, the separator of the present invention has a porosity of 40-70%. If the porosity is too low, the resistivity of the separator to conduct Li-ions becomes too low to enable fast charging and discharging. If the porosity of the separator is too high other properties may be insufficient. The porosity of separator according to the invention preferably is at least 45%, more preferably at least 50%. It may also be preferred for the separator to have a porosity of at most 65%, more preferably at most 60%, in some embodiments at most 55%.

An important feature is the ionic resistivity of the separator which should be as good as possible. An important FIGURE to characterize the ion mobility of a certain separator electrolyte combination is the so called MacMullin number which is defined as ratio between the resistivity of a separator saturated with electrolyte and that of the pure electrolyte and is therefore always larger than 1. The MacMullin number for the separator according to the invention preferably is at most 10, in particular at most 8, more preferably at most 6. It is particularly preferred for the MacMullin number to be at most 5, more in particular at most 4.

A particular useful parameter to characterize the conductivity of the separator is a Conductivity Performance Value which is defined as:

$$CPV = ε \% / ( t ⋆ p * MM )$$

wherein

ε%=(1−AW/(r*t))*100%, is the porosity (%)
r=density (g/cm3)
AW=areal density (g/m2)
p=surface pore size (μm)
t=thickness (μm)
MM=MacMullin number

The CPV combines a number of relevant parameters for the separator. It is preferred for the CPV to be at least 0.5, in particular at least 5, more in particular at least 10, in some embodiments at least 20.

The invention also pertains to a battery cell comprising the separator of the present invention. The battery cell according to the invention comprises a lithium-containing cathode and an anode connected through a lithium-containing electrolyte, wherein the anode and cathode are separated from each other through a separator as described herein. The invention also pertains to a battery comprising one or more battery cells as discussed above, and to a module comprising one or more batteries as described above.

It will be clear to the skilled person that various preferred embodiments described herein can be combined, unless they are mutually exclusive.

The invention is illustrated by the following examples, without being limited thereto or thereby.

### EXAMPLES

### General

The following materials were used in the examples:
para-aramid shortcut fibers with a length of 6 mm and a linear density of 0.55 dtex
para-aramid fibrid 8016 ex Teijin Aramid The Netherlands with a Schopper-Riegler (SR) value of >75° preferably >80°
PET fibers: TA04PN ex Teijin Frontier Japan with a length of 3 mm, a linear density of 0.06 dtex, and a diameter of about 3 μm.
Para-aramid pulp: 1094 ex. Teijin Aramid, The Netherlands with SR 55-60°
Para-aramid jet-spun pulp 8077 ex Teijin Aramid The Netherlands with CSF 50-100.

Core papers were manufactured through a conventional wet-laying process, in which the various constituents were mixed in an aqueous suspension followed by wet-laying paper process via an inclined wire machine. Papers were calendered to the desired thickness with steel-steel rollers at 120° C. Where a heat treatment is carried out, this is indicated separately.

The areal weight (Aw) can be determined in accordance with ASTM D646. The thickness and tensile properties can be determined in accordance with ISO 534 and ISO1924-3 respectively.

The MacMullin number can be determined at 25° C. by following the main procedure of the RHD application note (https://www.rhd-instruments.de/download/appnotes/application_note_macmullin_no.pdf) utilizing Metrohm Autolab PGSTAT204 with FRA32-module using 0.5 M LiClO4 in PC/EC/DME (22:8:70 w %) as electrolyte. Data acquisition and analysis can be performed by Nova 2.1 and RelaxIS software respectively. To avoid influence of contact resistance, the MacMullin can be determined from the slope of the resistivity as a function of the number of saturated and stacked separators.

### Example 1: Influence of the Presence of PET

Papers were prepared containing various amounts of para-aramid pulp, aramid shortcut, jetspun pulp, jet-spun fibrids and PET fibers. It will be clear that the presence of pinholes has to be avoided as much as possible. The appearance of pinholes in low grammage paper is a measure of insufficient formation uniformity. There are many approaches to reduce the number of pinholes including the utilization of additives like hydroxy ethylated starch, polyvinyl alcohol and carboxymethylcellulose. However, these substances has a negative influence on a battery performance.

It was found surprisingly that low titer PET fibers significantly improves the paper formation, as can be seen from the number of pinholes.

In the present specification pinholes are determined using the following method: To determine the number of pinholes an Epson Perfection V720 Pro scanner was used in combination with image analysis software Fiji-ImageJ. A paper sheet is placed on the glass of an optical scanner and covered with a black background paper. An image is taken with the following settings: image type: 16 bits, grey, optimal scan modus, resolution: 1200 dpi, format: w200-H200 mm. The image was further processed with the image analysis software with the following settings: set scale to calibrate: 9440 pixels, distance 200, pixel aspect ratio 11, unit of length mm, global on. This results in 47.2 pixels/mm. In measurement parameters-analyse, the following parameters were selected: area, standard deviation, center of mass, area fraction, fit ellipse, Feret's diameter, decimal places: 3. After inverting and selecting a circular area with a diameter of about 200 mm, the outer area was cleared and the threshold was set on the remaining area between 235 and 255. The module Analyze Particles was selected with the size: 0-infinity, circularity 0.00-1.00, show: Outlines, and ticked: Display results, Clear results and Summarize.

The results are presented in the following table.

| | aramid | aramid- | jet-spun | jet-spun | PET | |
|---|---|---|---|---|---|---|
| Sample | pulp | shortcut | fibrids | pulp | fibres | n |
| Code | % | % | % | % | % | pinholes |
| Comparative 1 | 35 | 30 | 35 | | | 58 |
| Comparative 2 | 35 | 30 | | 35 | | 47 |
| Sample 1 | 35 | 15 | 35 | | 15 | 11 |
| Sample 2 | 35 | | 35 | | 30 | 2 |
| Sample 3 | 35 | 15 | | 20 | 30 | 2 |
| Sample 4 | | 15 | 35 | 20 | 30 | 3 |
| Sample 5 | 35 | | 35 | | 30 | 2 |

From a comparison between Comparative 1 and Sample 1 it can be seen that replacing part of the aramid shortcut with PET fibers results in a better paper formation expressed in a substantial reduction of the number of pinholes as determined by the above method.

This phenomenon is not limited to the above listed paper compositions. It is seen that papers comprising 15-20 w % low titer PET show a better formation than papers without PET with an otherwise comparable composition.

### Example 2: Effect of Heat Treatment

Various experiments were carried out to investigate the effect of heat treatment on the paper.

Effect on paper without PET A paper was prepared comprising 20 wt. % jet-spun pulp and 80 wt. % shortcut fibers. The paper was submitted to a heat treatment in an oven for 30 minutes at 250° C.

The results are as follows:

| | Heat treatment | AW | t | BF | BT | EaB |
|---|---|---|---|---|---|---|
| Test | t min - T ° C. | gsm | μm | N/m | MPa | % |
| Comparative 1 | no | 9.1 | 61 | 129 | 2.11 | 0.47 |
| Comparative 2 | 30 - 250 | 8.7 | 63 | 153 | 2.43 | 0.41 |

As can be seen from the table, the heat treatment results in a minor increase in breaking force (BF) and breaking tenacity (BT). (Note that the variations in AW are due to irregularities in the paper compositions).

Effect on Paper with PET

A paper was prepared comprising 20 wt. % jet-spun pulp, 50 wt. % shortcut fibers, and 30 wt. % PET fibers. The paper was submitted to a heat treatment in an oven for 30 minutes at 200 or 250° C. The results are as follows:

| | Heat treatment | AW | t | BF | BT | EaB |
|---|---|---|---|---|---|---|
| Test | t min - T ° C. | gsm | μm | N/m | MPa | % |
| no heating | no | 10.4 | 57 | 135 | 2.37 | 0.49 |
| Sample 1 | 30 - 200 | 10.0 | 55 | 180 | 3.26 | 0.51 |
| Sample 2 | 30 - 250 | 9.1 | 56 | 406 | 7.25 | 0.70 |

As can be seen from the table, the heat treatment, in particular that at 250° C., results in a significant increase in breaking force (BF), breaking tenacity (BT), and elongation at break (EaB).

### Effect of Heating Temperature

A paper was prepared comprising 15 wt. % jet-spun pulp, 55 wt. % shortcut fibers, and 30 wt. % PET fibers. The paper was submitted to a heat treatment in an oven for 30 minutes at 250 or 270° C. The results are as follows:

| | Heat treatment | AW | t | BF | BT | EaB |
|---|---|---|---|---|---|---|
| Test | t min - T ° C. | gsm | μm | N/m | MPa | % |
| no heating | no | 10.4 | 21 | 227 | 10.8 | 0.62 |
| Sample 1 | 3 - 250 | 10.5 | 24 | 406 | 16.9 | 1.02 |
| Sample 2 | 3 - 270 | 10.2 | 24 | 1180 | 49.2 | 1.47 |

As can be seen from the table, the heat treatment, at 250° C. and even more pronounced at 270° C., results in a significant increase in breaking force (BF), breaking tenacity (BT), and elongation at break (EaB).

### Effect of Heating Temperature on Further Paper Composition

A paper was prepared comprising 15 wt. % jet-spun pulp, 60 wt. % shortcut fibers, and 25 wt. % PET fibers. The paper was submitted to a heat treatment in an oven for 30 minutes at 270° C. The results are as follows:

| | Heat treatment | AW | t | BF | BT | EaB |
|---|---|---|---|---|---|---|
| Test | t min - T ° C. | gsm | μm | N/m | MPa | % |
| no heating | no | 8.8 | 18 | 127 | 7.1 | 0.40 |
| Sample 1 | 3 - 270 | 8.9 | 20 | 775 | 38.7 | 1.34 |

As can be seen from the table, also for this composition the heat treatment at 270° C. results in a significant increase in breaking force (BF), breaking tenacity (BT), and elongation at break (EaB).

### Heat Treatment Under Dynamic Conditions

A paper was prepared comprising 15 wt. % jet-spun pulp, 55 wt. % shortcut fibers, and 30 wt. % PET fibers. The paper was submitted to a heat treatment under dynamic conditions by passing it over a hotplate on a PTFE foil, at 0.5 m/min with a residence time of 3 minutes at different temperatures.

The results are as follows:

| | Heat treatment | AW | t | BF | BT | EaB |
|---|---|---|---|---|---|---|
| Test | v m/min - t min - T ° C. | gsm | μm | N/m | MPa | % |
| Sample 1 | 1 - 1.5 - 260 | 10.0 | 22 | 957 | 44.3 | 1.23 |
| Sample 2 | 1 - 1.5 - 272 | 9.6 | 19 | 907 | 49.5 | 1.18 |

The same paper was also subjected to heating with an IR heater. The results are as follows:

| | Heat treatment | | | | | |
|---|---|---|---|---|---|---|
| | v m/min -P, W | | | | | |
| | (estimated temperature | AW | t | BF | BT | EaB |
| Test | 280° C.) | gsm | μm | N/m | MPa | % |
| no heating | no | 9.8 | 16 | 270 | 16.5 | 0.65 |
| Sample 1 | 1-55 | 9.9 | 20 | 1097 | 53.5 | 1.41 |
| Sample 2 | 1-55 | 9.7 | 20 | 1091 | 53.5 | 1.44 |
| Sample 3 | 1-60 | 9.7 | 20 | 889 | 43.3 | 1.18 |
| Sample 4 | 1-65 | 9.5 | 21 | 1064 | 50.7 | 1.28 |

The same paper was also heat-treated in a laminator with double-belt transportation. The results are as follows:

| | Heat treatment | | | | | |
|---|---|---|---|---|---|---|
| | v m/min - P | AW | t | BF | BT | EaB |
| Test | N/cm2 - T ° C. | gsm | μm | N/m | MPa | % |
| Sample 1 | 2 - 25 - 250 | 9.9 | 20 | 507 | 25.2 | 1.18 |
| Sample 2 | 2 - 50 - 250 | 9.5 | 18 | 595 | 32.7 | 1.27 |
| Sample 3 | 2 - 100 - 250 | 9.8 | 18 | 515 | 28.1 | 1.09 |

The same paper was also heat treated on a hot roll at 290° C. at different speeds. The results are as follows:

| | | | AW | t | BF | BT | EaB |
|---|---|---|---|---|---|---|---|
| Test | | | gsm | μm | N/m | MPa | % |
| no heating | — | | 9.8 | 19 | 270 | 16.5 | 0.65 |
| Sample 1 | 10 | m/min | 9.5 | 21 | 1291 | 60.6 | 2.00 |
| Sample 2 | 5 | m/min | 10.0 | 24 | 1235 | 52.6 | 1.76 |
| Sample 3 | 2.5 | m/min | 10.0 | 26 | 1347 | 51.3 | 1.77 |

### Example 3: Coating of Papers Through Continuous Processing

A paper was prepared having the following composition: 30 wt. % jet-spun fibrid, 26 wt. % para-aramid pulp, 32 wt. % aramid shortcut, and 12 wt. % PET fibers. The paper was prepared as described above.

The paper was coated in a continuous operation using various coating methods.

The aqueous coating was a liquid comprising Al2O3 and polyvinylpyrrolidone (molecular weight 1.3 M g/mol) in a mass ratio of 95:5.

The coated papers were dried in an oven with three drying sections, set at respectively 85° C., 85° C., and 95° C.

The coated papers were tested to determine various properties. The results are presented below.

| | | | | | | | Average | | |
|---|---|---|---|---|---|---|---|---|---|
| | | Speed | Coating | AW | t | ε | surface pore | MacMullin | |
| Sample | Technology | m/min | Solids, % | gsm | μm | % | size, μm | — | CPV |
| Core paper | — | — | — | 15.5 | 31 | 65 | 17.0 | 4.6 | 0.03 |
| 1 (no | | | | | | | | | |
| coating) | | | | | | | | | |
| Sample 1 | u-roller | 1 | 15 | 17.0 | 31 | 62 | 0.08 | 3.2 | 8 |
| Sample 2 | u-roller | 8 | 15 | 18.5 | 34 | 61 | 0.08 | 3.9 | 6 |
| Sample 3 | Foulard | 1 | 20 | 17.5 | 32 | 61 | 0.07 | 3.7 | 8 |
| Sample 4 | Foulard | 1 | 20 | 16.5 | 35 | 67 | 0.07 | 3.0 | 9 |
| Sample 5 | Doctor-blade | 1 | 20 | 22.0 | 36 | 56 | 0.07 | 2.1 | 11 |
| Sample 6 | Doctor-blade | 1 | 20 | 22.5 | 38 | 57 | 0.07 | 3.4 | 6 |

All Samples showed a surface pore size on the side of the paper provided with the coating layer which is such that at least 95 number % of the surface pores has a pore size of at most 0.5 micron and at least 80 number % of the surface pores has a pore size of at most 0.3 micron.

As can be seen from the table, different coating methods all result in papers with good properties.

### Example 4: Coating Solution with Aramid Polymer

In a continuous 3-roll coating device with a gap between 70 and 95 μm each and operating at 1 m/min a coating mixture of 81.9 wt. % of a solution of CaCl2 in N-methyl-pyrrolidone (4.5 w %), 1.8 wt. % of a copolymerized polyparaphenyleneterephthalamide containing, as a copolymerized diamine component, 3,4′-oxydiphenylenediamine in an amount of 50 mol %, based on the mole of the all diamine components manufactured by Teijin Aramid and 16.3 wt. % Al2O3 was applied to a paper based on 30 wt. % jet-spun fibrid, 26 wt. % para-aramid pulp, 32 wt. % aramid shortcut, and 12 wt. % PET fibers. The paper was prepared as described above.

During the coating process, the paper was supported by a PET-foil (Melinex ST504 ex. DuPont). The coated paper was conducted through a couple of demi water bathes to wash out the NMP/CaCl2, resulting in solidification of the polymer. The conductivity at the end of the wash water was max 9.9 μS/cm indicating good removal of the ions. The paper was released from the support foil and dried in an oven, which contained 5 different heating zones set at 90° C., 100° C., 110° C., 120° C. and 120° C. respectively.

The results are provided in the following table.

| | | | | | Average | | |
|---|---|---|---|---|---|---|---|
| | t gap | AW | t | 3 | surface pore | | |
| No | μm | gsm | μm | % | size, μm | MM | CPV |
| Core paper 2 | — | 10.7 | 18 | 60 | 3.7 | 3.6 | 0.24 |
| (no coating) | | | | | | | |
| Sample 1 | 70 | 23.2 | 26 | 66 | 0.02 | 2.0 | 63 |
| Sample 2 | 90 | 13.9 | 20 | 65 | 0.03 | 3.8 | 29 |
| Sample 3 | 90 | 16.4 | 22 | 67 | 0.05 | 3.6 | 17 |
| Sample 4 | 95 | 14.1 | 22 | 69 | 0.03 | 4.0 | 26 |

All Samples showed a surface pore size on the side of the paper provided with the coating layer which is such that at least 95 number % of the surface pores has a pore size of at most 0.5 micron and at least 80 number % of the surface pores has a pore size of at most 0.3 micron.

As can be seen from the table above, the application of this coating results in a separator paper with very good properties.

Core papers 1 and 2 from Examples 3 and 4 were subjected to a heat treatment at 150° C. for 0.5 h. The shrinkage of the paper and separator was 0.2% and 0.4% respectively which is very low, illustrating the dimensional stability of the paper and separator.

### Example 5: Alternative Binder—Heat-Resistant Polyester

In this example, papers were prepared comprising aramid shortcut fibers, PET fibers and a binder based on a polyester dispersion with hexamethoxymethylmelamine as crosslinker. This binder will be further indicated as x-linked binder.

The papers had the following compositions:
Paper A: 50 w % aramid shortcut fibers, 20 w % PET fibers and 30 w % x-linked binder.
Paper B: 55 w % aramid shortcut fibers, 20 w % PET fibers and 25 w % x-linked binder.
Paper C: 55 w % aramid shortcut fibers, 30 w % PET fibers and 15 w % x-linked binder.
The papers were calendered at 125° C. and heat treated at 290° C. on a hot roll at 10 m/min.

A coating composition was prepared by mixing Al2O3 with a solution of 3 w % copolymerized polyparaphenyleneterephthalamide containing, as a copolymerized diamine component, 3,4′-oxydiphenylenediamine in an amount of 50 mol %, based on the mole of the all diamine components, dissolved in NMP/CaCl2) (4,5 w %). Different polymer/Al2O3 ratios were applied. Paper A was coated with the coating composition using a doctor blade (DB) or Mayer bar (MB). After coating, the coated paper was contacted with NMP/water=25/75 to solidify the polymer. The paper was washed with demineralised water, and dried at 95° C. The properties of the resulting separators are provided in the following table.

| | | | | | | Average | | |
|---|---|---|---|---|---|---|---|---|
| | | | | | | surface | | |
| | | | A.w. | t | Por | pore size | MacMullin | |
| No | polymer/Al2O3% | Blade | gsm | μm | % | μm | — | CPV |
| Paper A | — | — | 8.9 | 18 | 57% | 52 | 5.0 | 0.01 |
| Sample 1 | 30/70 | DB 50 μm | 12.5 | 22 | 62% | 0.05 | 3.8 | 15 |
| Sample 2 | 30/70 | DB 40 μm | 12.0 | 22 | 54% | 0.05 | 4.9 | 10 |
| Sample 3 | 10/90 | DB 40 μm | 18.8 | 24 | 50% | 0.05 | 4.8 | 9 |
| Sample 4 | 30/70 | MB10 | 11.5 | 20 | 63% | 0.05 | 4.8 | 13 |
| Sample 5 | 30/70 | MB14 | 12.5 | 21 | 62% | 0.05 | 5.3 | 11 |
| Sample 6 | 30/70 | MB18 | 14.8 | 26 | 61% | 0.05 | 4.3 | 11 |

Paper B was coated through an analogous process. The results are presented in the following table.

| | | | | | | Average | | |
|---|---|---|---|---|---|---|---|---|
| | | | | | | surface | | |
| | | Blade | A.w. | t | Por | pore size | MacMullin | |
| No | copol/Al2O3% | μm | gsm | μm | % | μm | — | CPV |
| Paper B | — | — | 7.6 | 13 | 66% | 52 | 4.5 | 0.13 |
| Sample 7 | 30/70 | DB 40 μm | 11.5 | 15 | 62% | 0.08 | 3.6 | 74 |
| Sample 8 | 10/90 | DB 40 μm | 16.6 | 21 | 59% | 0.08 | 3.6 | 76 |
| Sample 9 | 5/95 | DB 40 μm | 25.0 | 24 | 56% | 0.08 | 3.3 | 75 |

Paper C was used to investigate different coating compositions. A first coating composition was prepared by mixing Al2O3 with a solution of 3 w % copolymerized polyparaphenyleneterephthalamide containing, as a copolymerized diamine component, 3,4′-oxydiphenylenediamine in an amount of 50 mol %, based on the mole of the all diamine components, dissolved in NMP/CaCl2) (4,5 w %). For this first coating a polymer/Al2O3 ratio of 15/85 was applied. This coating was applied to obtain Sample 10. To obtain Sample 11 a further coating was prepared, containing boehmite rather than alumina. To obtain sample 12 a coating was used which contained PVDF (polyvinylideendifluoride) to improve adhesion with the electrodes. Sample 13 was prepared using the same coating as Sample 10, except that a thicker coating layer was applied, as can be seen from the higher areal weight.

Paper C was coated as described in Example 4 except a slot-die coating device in contact mode with an opening of 100 μm was used. The system was operated at 4 m/min.

| | | | | | | Average | |
|---|---|---|---|---|---|---|---|
| | | | | | | surface | |
| | | | | | | pore | |
| | | A.W. | t | ε | MM | size | |
| Paper | Coating | gsm | μ | — | — | (micron) | CPV |
| Paper C | — | 7.3 | 12 | 0.61 | 3.2 | 16 | 0.10 |
| Sample 10 | copolymer/Al2O3 = 15/85 | 13.1 | 17 | 0.67 | 3.8 | 0.013 | 80 |
| Sample 11 | copolymer/Boehmite = 15/85 | 12.7 | 16 | 0.59 | 4 | 0.02 | 46 |
| Sample 12 | copolymer/PVDF/Al2O3 = 15/33/73 | 14.7 | 15 | 0.57 | 4.2 | 0.03 | 30 |
| Sample 13 | copolymer/Al2O3 = 85/15 15/85 | 12.9 | 14 | 0.61 | 5.3 | 0.02 | 41 |

As can be seen from these tables, in particular from the CPV, papers with good separator properties were obtained. All Samples showed a surface pore size on the side of the paper provided with the coating layer which is such that at least 95 number % of the surface pores has a pore size of at most 0.5 micron and at least 80 number % of the surface pores has a pore size of at most 0.3 micron.

FIG. 1a shows a SEM photograph of the surface of sample 11. FIG. 1b shows an enlargement of the box which can be seen in FIG. 1a. The black “holes” are the surface pores. The diameter of the surface pores can be determined from the SEM picture.

### Example 6: Alternative Binders—Acrylate and PVP

Papers were prepared using different binders, namely an acrylate binder (AkzoNobel Cetabever Blanc 0103, 32 wt. % solids) and a polyvinyl pyrrolidone binder (PVP K60 Ashland 46.5 wt. % solids). All papers contained 30 wt. % aramid shortcut, 30 wt. % PET fiber, and 40 wt. % of the binder (calculated as solids content).

The papers were prepared as follows: A handsheet was prepared from PET fibers and the aramid shortcut. The sheets were subsequently sprayed with the respective binder compositions, and dried between two hotplates at 105° C. for at least 6 minutes. The sheets were removed from the carrier board and weighed. If necessary to achieve the final resin content, the treatment was repeated. The sheets are subjected to a calendering step under the following conditions: PVP containing sheets: 125° C., acrylate-containing sheets 35° C. Then, a heat treatment was carried out at 270° C. for 3 min.

The properties of the final papers are presented in the following table.

| | | | | Air | | | |
|---|---|---|---|---|---|---|---|
| | binder | T | AW | permeability | BF | BT | |
| Sample | type | (micron) | (gsm) | (mm/s) | (N/m) | (MPa) | ε (%) |
| 1 | acrylate | 24 | 12 | 1111 | 267 | 21.3 | 50 |
| 2 | PVP | 26 | 13 | 1294 | 587 | 13 | 50 |

The papers were coated using the coating applied for Paper C, Sample 10 in Example 5, i.e. 3 wt. % copolymer in NMP/CaCl2) as solvent, using alumina as inorganic oxide. The ratio of copolymer to alumina was 15:85.

| | binder | Surface pore | | |
|---|---|---|---|---|
| Sample | type | size (micron) | MM | CPV |
| 1 | acrylate | 0.05 | 2.9 | 15 |
| 2 | PVP | 0.06 | 1.6 | 21 |

This example shows that the use of polymer binders also allows the production of good quality separator papers. Both Samples showed a surface pore size on the side of the paper provided with the coating layer which is such that at least 95 number % of the surface pores has a pore size of at most 0.5 micron and at least 80 number % of the surface pores has a pore size of at most 0.3 micron.

### Example 7: Water-Based Coatings

A paper was produced comprising 55 w % aramid shortcut fibers, 30 w % PET fibers and 15 w % of a -linked polyester binder system. The paper was calendered at 125° C. and heat treated on a hot roll at 285° C. at 10 m/min and finally slit in 100 mm wide paper.

The following coating compositions were prepared:

| | Coating 1 | Coating 2 |
|---|---|---|
| Material | (wt. %) | (wt. %) |
| Water | 57.1 | 65.0 |
| Boehmite | 33.3 | 28.7 |
| Soteras CCS-V¹ | 9.4 | 6.2 |
| Soteras CCS-B | 0.21 | 0.12 |
| Atlox 1045A | | 0.016 |

Soteras CCS-V (Ashland): Poly(1-vinylpyrrolidone-co-2-dimethylaminoethyl methacrylate) (cas 30581-59-0).
Soteras CCS-B (Ashland): cross linking resin based on water soluble D-Sorbitol diglycidyl ether (cas 68412-01-1) and glycerol triglycidyl ether (cas 25038-04-4).
Atlox 1045A (Croda): a polyoxyethylene (30) sorbitol oleate-laurate wetting agent or dispersant.

A coating layer with a width of 80 mm was applied onto the paper described above through a slot-die contact mode coating process, followed by contactless drying in two hot air ovens at 80° C. and 120° C. respectively. The properties of the papers thus obtained are provided in the following table.

| | | | | Average | | |
|---|---|---|---|---|---|---|
| | AW | t | e | surface pore | MacMullin | |
| Sample | gsm | μm | % | size, μm | — | CPV |
| starting paper | 7.1 | 13 | 59 | 17.0 | 2.9 | 0.09 |
| Coating 1 | 13.5 | 17 | 62 | 0.50 | 4.4 | 10.5 |
| Coating 2 | 14.6 | 14 | 51 | 0.50 | 5.8 | 5.8 |
| Coating 3 | 15.9 | 15 | 52 | 0.50 | 6.2 | 5.1 |

Coating 1 was applied at a speed of 2 m/min and a thickness of 50 micron. Coating 2 was applied at a speed of 1 m/min and a thickness of 100 micron. Coating 3 was applied in the same way as Coating 2, except that a slightly thicker coating layer were applied, as can be seen from a higher areal weight.

It can be seen from the CPV values in the table that separator papers with good properties are obtained. All Samples showed a surface pore size on the side of the paper provided with the coating layer which is such that at least 95 number % of the surface pores has a pore size of at most 0.5 micron and at least 80 number % of the surface pores has a pore size of at most 0.3 micron

### Example 8: Effect of the Three Components

To illustrate the effect of the presence of the three components, namely aramid shortcut, PET, and binder, an example and two comparative examples were prepared. The binder was an aramid fibrid binder. The composition of the various papers is provided in the following table:

| | | | | | | air |
|---|---|---|---|---|---|---|
| | shortcut | binder | PET | t | AW | permeability |
| | (wt. %) | (wt.) | (wt. %) | (micron) | gsm | (mm/s) |
| Example 1 | 50 | 20 | 30 | 62 | 13 | 1412 |
| Comparative A | 50 | 50 | 0 | 62 | 13 | 456 |
| Comparative B | 50 | 0 | 50 | n.d. | n.d. | n.d. |

n.d. stands for not determined.

The strength of the paper containing PET and shortcut but no binder was so low that the sheet could not be handled. Accordingly, further properties were not determined.

The sheets of Example 1 and comparative Example A were subjected to a calendering step at 125° C. and a heat treatment at 270° C. for 3 min. after which further properties were determined. The results are in the following table:

| | | air | | | | |
|---|---|---|---|---|---|---|
| | t | permeability | Apparent n | BF | BT | EaB |
| | (micron) | (mm/s) | pinholes | (N/m) | (N/m) | (%) |
| Example 1 | 19 | 314 | 503 | 981 | 32.9 | 1.33 |
| Comparative A | 17 | 273 | 9230 | 422 | 16.5 | 1.07 |

As can be seen from this table, a paper containing only aramid fibrid and not PET has a much higher number of pinholes at the same PET content. It is noted that an absolute comparison with the papers of Example 1 cannot be made, in view of the differences in composition, in particular in shortcut content.

1. Separator suitable for use in lithium ion batteries which comprises a core paper comprising 30-70 wt. % aramid shortcut fiber, 10-45 wt. % PET, and 5-40 wt. % of a binder, the core paper having a grammage of 5-30 g/m2 and a thickness of 5-30 micron, wherein at least one side of the core paper is provided with a coating layer, said coating layer comprising refractory particles and a coating binder, wherein the separator has a surface pore size on the side of the paper provided with the coating layer which is such that at least 90 number % of the surface pores has a pore size of at most 0.5 micron.

2. Separator according to claim 1, wherein at least 95 number % of the surface pores has a pore size of at most 0.50 micron.

3. Separator according to claim 1, wherein the core paper has a grammage of at least 7 g/m2.

4. Separator according to claim 1, wherein the aramid in the core paper consists for at least 20 wt. % of para-aramid.

5. Separator according to claim 1, wherein the binder is selected from one or more of aramid fibrid, aramid pulp, jetspun aramid fibrid, jetspun aramid pulp, and combinations thereof.

6. Separator according to claim 1, wherein the amount of PET in the core paper is PET to be at least 15 wt. %.

7. Separator according to claim 1, which has a porosity of 40-70% and/or a MacMullin number of 10-1 and/or a CPV of at least 4.

8. Core paper suitable for use in a separator according to claim 1, comprising 30-70 wt. % aramid shortcut fiber, 10-45 wt. % PET, and 5-40 wt. % of a binder, the core paper having a grammage of 5-30 g/m2 and a thickness of 5-30 micron.

9. Method for manufacturing a core paper according to claim 8,
comprising the steps of providing a suspension comprising at least part of the paper components, applying the suspension to a porous screen to form a web, removal of liquid medium from the web, and drying the paper.

10. Method according to claim 9, wherein the PET is incorporated in the core paper in the form of fibers with a linear density of at most 0.15 dtex.

11. Method according to claim 9, wherein the core paper is subjected to a heat treatment at a temperature of at least 175° C.

12. Method for manufacturing a separator according to claim 1, comprising the steps of
providing a core paper comprising 30-70 wt. % aramid shortcut fiber, 10-45 wt. % PET, and 5-40 wt. % of a binder, the core paper having a grammage of 5-30 g/m2 and a thickness of 5-30 micron, and
providing at least one side of the core paper with a coating layer by contacting at least one side with a composition comprising refractory particles and a coating binder.

13. Li-ion battery cell comprising a lithium-containing cathode and an anode connected through a lithium-containing electrolyte, wherein the anode and cathode are separated from each other through a separator according to claim 1.

14. Battery module comprising at least one Li-ion battery cell according to claim 13.

15. (canceled)
